(19) United States
(12) Patent Application Publication
(10) Pub. No.: US 2015/0290701 A1
(43) Pub. Date: Oct. 15, 2015

(54) MACHINE TOOL AND METHOD FOR MACHINING A WORKPIECE

(71) Applicant: WFL Millturn Technologies GmbH & Co. KG, Linz (AT)

(72) Inventors: Herbert Maringer, Sattledt (AT); Reinhard Koll, Lichtenberg (AT)

(21) Appl. No.: 14/432,198

(22) PCT Filed: Sep. 27, 2013
(86) PCT No.: PCT/AT2013/050197

§ 371 Date: Mar. 28, 2015

(30) Foreign Application Priority Data
Sep. 28, 2012 (AT) A 50417/2012

(51) Int. Cl. B21J 5/00; C22C 14/00; C22F 1/18; B23P 9/04; B23P 23/04

(52) U.S. Cl. CPC B21J 5/002; B21J 5/008; B23P 9/04; B23P 23/04; C22F 1/183; C22C 14/00

(57) ABSTRACT

A machine tool and method for machining a workpiece into a finished part in which the workpiece is damped into a machine tool and is machined in a material-removing fashion with a tool that has a geometrically defined cutting edge and is fastened to a multiaxially mobile tool holder of the machine tool. In order to ensure the maximum dimensional and size accuracy in the finished part, it is proposed that the workpiece, after its material-removing machining and in the same clamping set-up used for the latter, is incrementally cold forged in at least some regions with the aid of a forging tool to produce the finished part.

### FIELD OF THE INVENTION

The invention relates to a machine tool and method for machining a workpiece into a finished part in which the workpiece is clamped into a machine tool and is machined in a material-removing fashion with a tool that has a geometrically defined cutting edge and is fastened to a multiaxially mobile tool holder of the machine tool.

### BACKGROUND OF THE INVENTION

Workpieces composed of titanium or a titanium alloy have a comparatively low modulus of elasticity as well as a comparatively low thermal conductivity, which can lead to considerable difficulties in methods used for hard machining them. On the one hand, this causes high mechanical and thermal stresses on the tools used and on the other hand, the temperatures that occur during the material-removing machining can lead to surface stresses on the workpiece and can negatively affect its fatigue strength. In order to reduce the risk of damage to the workpiece, a hard grinding of the titanium workpiece is generally avoided and its final shape is produced b hard milling and/or hard turning. But even with these methods, it is not possible to entirely rule out the occurrence of increased temperatures, which is why DE 69422599 T2 has proposed using lubricating; fluid to intensively cool the cutting, plates of the tool and the workpiece in the region in which it is being machined—even more so when machining forged high-strength workpieces into finished parts such as engine components, chassis components, or load-bearing structural components whose material-removing machining depth varies comparatively often, thus making it difficult to establish cutting data for the machining process. Unfavorable cutting data, however, can result in considerable thermomechanical stresses in the vicinity of the workpiece edge zone, which can subsequently result in undesirable mechanical properties in the finished part.

An incremental cold forging method is also known from the prior art (DE 102009025621 B4), in which a metallic component is provided with a hardened surface. The forging tool used for this can be guided by a robot or a machine tool.

### SUMMARY OF THE INVENTION

Based on the prior art explained above, the object of the invention is to create a method for machining high-strength workpieces, which ensures short machining times and also is able to ensure a high dimensional and size accuracy in the finished part. In particular, the machining method should be able to cope, for example, with forged workpieces made of a Ti-5Al-5V-5Mo-3Cr alloy (Ti-5553) with a hardness of greater than 40 HRC and a strength of greater than 1200 N/mm2 without negatively affecting the fatigue strength of the workpieces,

The invention attains the stated object with regard to the method in that the workpiece, after its material-removing machining and in the same clamping set-up used for the latter, is incrementally cold forged in at least some regions with the aid of a forging tool to produce the finished part.

If the workpiece, after being subjected to material-removing machining is incrementally cold forged in at least some regions with the aid of the forging tool to produce the finished part, then the requirements in the material-removing finish machining—in particular a fine-grinding—of the workpiece can be reduced because this cold micro-forging technique is able to ensure the required dimensional and size accuracy in the finished part. These advantages turn out to be particularly important when the final forging process is carried out in the same clamping set-up that is also used in the preceding material-removing, machining. Advantageously, the same process settings on the machine tool for the cutting and the subsequent shaping can be used for the finishing of the high-strength workpiece. It is therefore unnecessary to abandon the integrated production process of the machine tool so that in comparison to the prior art, consistently quicker machining times and thus reduced cycle times can be expected. In addition, the use of a micro-forging technique can keep the heating of the workpiece within strict limits, which makes it possible to avoid negative effects on its fatigue strength. The method according to the invention can therefore also reproducibly insure a comparatively high dimensional and size accuracy in the finished part.

The method according to the invention can be particularly advantageous when machining a forged workpiece, particularly if the workpiece in this case is made of titanium or a titanium alloy and therefore constitutes a high-strength workpiece.

The method according to the invention can enable a material-removing hard machining of the workpiece with the tool, and an incremental cold forging immediately after this hard machining. Even high-strength workpieces with a hardness of greater than 40 HRC (hardness according to Rockwell scale C) can thus be machined to produce finished parts, even if their cutting depth varies comparatively often, which can be the case, for example, due to imprecisions in the workpiece caused by a preceding forging process. An additional finishing treatment of the workpiece edge zone, which can be required due to suboptimal cutting data in the material-removing hard machining, is now possible through the cold forging according to the invention. It can also be advantageous if the workpiece is incrementally cold forged immediately after the material-removing machining. It is thus possible, for example, avoid the risk of unwanted storage-induced strain hardening phenomena in workpiece, which makes it possible to further increase the dimensional and size accuracy of the finished part.

Hard milling and/or hard turning can be particularly advantageous in the above-mentioned material-removing hard machining.

If the material-removing tool of the tool holder is replaced with a forging tool for the incremental cold forging, then the workpiece can be finished with a reduced control complexity. The production process according to the invention is thus able to achieve a reduction in costs.

The operation sequence can be further optimized if the workpiece is machined into the finished part in one clamping set-up on the machine tool. In addition, this can also reduce the risk of damage to the workpieces during the operation sequence, for example damage caused by transport, reclamping, etc. Because of this simplification in handling, the method according to the invention can thus achieve significant advantages in the production of comparatively cost-intensive forged high-strength workpieces.

An advantageous positioning of the tool relative to the workpiece can be achieved with a tool holder that is able to move in four axes, permitting a particularly exact machining of the clamped workpiece. Particularly also in cold forging, this can be crucial for a comparatively high dimensional and size accuracy.

Advantageous processing conditions can be achieved if the workpiece is cold forged with an electrodynamic forging tool since the multiaxially mobile tool holder merely serves to adjust the forging tool during the process. The forging process can be carried out in a highly dynamic fashion specifically by means of the electrodynamically controlled movement of the impact head of the forging tool. It is thus possible to achieve an extremely precise and also reproducible incremental cold forging of the workpiece.

Another object of the invention is to modify a machine toot of the type described at the beginning in a structurally simple way so that it can be used to completely machine a high-strength workpiece into a finished part. In addition, the machine tool should make it possible to achieve a high dimensional and size accuracy even in forged workpieces, particularly ones that are made of a Ti-5Al-5V-5Mo-3Cr alloy (Ti-5553).

The invention attains the stated object in that the machine tool includes a forging tool, which is for performing the incremental cold forging of the workpiece and whose impact head is guided along a trajectory that is independent of the movement axes of the tool holder.

Because the machine tool includes a forging tool for incrementally cold forging the workpiece, unwanted thermodynamic properties in the workpiece that are caused by a preceding material-removing hard machining can be compensated for so that a comparatively high dimensional and size accuracy in the finished part can be achieved. This high dimensional and size accuracy in the finished part can be additionally improved if the impact head of the forging tool is guided along a trajectory that is independent of the movement axes of the tool holder because this permits the incremental cold forging to be carried out independent of guidance parameters of the tool holder. As a result, even forged workpieces made of a Ti-5553 alloy can be finished with dimensional and size accuracy. The machine tool according to the invention can therefore permit a complete machining of the workpiece into the finished part without having to abandon the clamping set-up for the material-removing machining of the workpiece, thus achieving a significant improvement over the prior art.

The structural complexity in a working space of the machine tool can be reduced if the tool holder has a connection for controlling and/or supplying energy to the electromagnetic forging tool that it holds.

The machine tool according to the invention can be particularly advantageous if it has a forged workpiece made of titanium or a titanium alloy and machines it into a finished part.

### BRIEF DESCRIPTION OF THE DRAWINGS

The method according to the invention will be described in greater detail below in conjunction with an exemplary embodiment shown in the drawings. In the drawings:

FIG. 1 shows a side view of a machine tool for complete machining and

FIGS. 2 and 3 show enlarged views of the tool holder of the machine tool shown in FIG. 1.

### DETAILED DESCRIPTION OF THE PREFERRED EMBODIMENTS

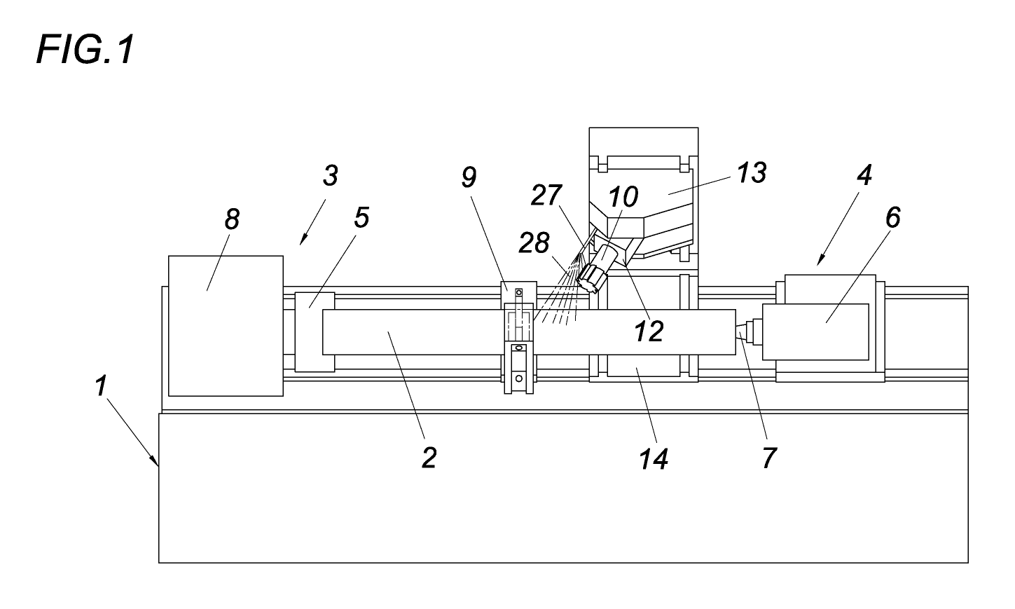

The machine tool 1 shown FIG. 1 has a clamped, forged workpiece 2 made of a Ti-5Al-5V-5Mo-3Cr alloy (Ti-5553). For this purpose, the workpiece 2 is grasped by a plurality of clamping elements 3 and 4, namely a clamping chuck 5 and at the opposite end, a tailstock 6, which clamps the end of the workpiece 2 with a centering pin 7. The chuck 5 is connected to a spindle drive 8 in order to be able to clamp the workpiece 2 in rotary fashion. For additional centering of the workpiece 2, a steady rest 9 is also provided, which can also function as a grip in the sense of a clamping element. The machining of the workpiece 2 is carried out among other things using a tool 10 that has a geometrically defined cutting edge 18 (e.g. a milling tool) and is fastened to a multiaxially mobile tool holder 12 of the machine tool 1. To embody this multiaxial mobility, the tool holder 12 is mounted in pivoting fashion on an auxiliary slide 13, which is fastened in a linearly slidable fashion to a linearly slidable main slide 14.

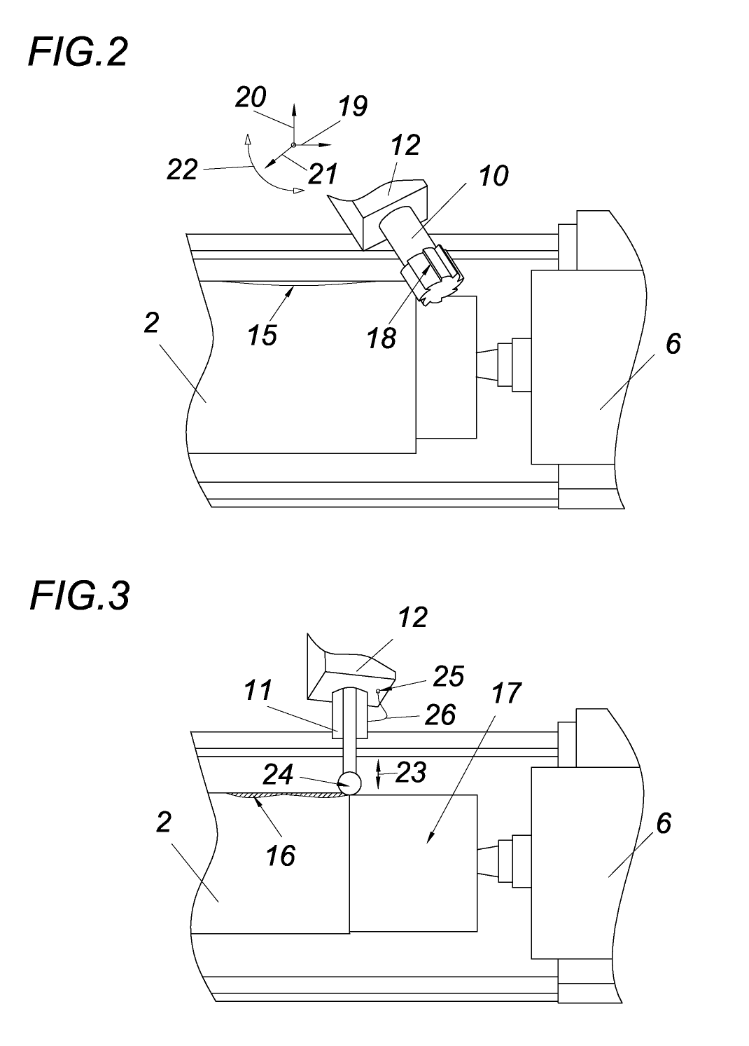

Since the dimensions of a forged high-strength workpiece 2 vary comparatively often, which has been suggested in FIG. 2 with a depression 15 on the workpiece 2, the cutting data established in the hard milling with the tool 10 can vary unexpectedly. Suboptimal machining conditions can therefore occur during finishing, producing a region 16 with undesirable machining results, which has been depicted by region 16 in FIG. 3.

According to the invention, the workpiece 2, after its hard machining shown in FIG. 3, is incrementally cold forged into the finished part 17 with the aid of a forging tool 11 and is thus also subjected to a finishing, treatment in order to thus obtain the desired dimensional and size accuracy. Since the clamping set-up is maintained during the hard machining according to FIG. 2 and during, the cold forging according to FIG. 3, a high dimensional and size accuracy is ensured, even in a workpiece 2 made of a Ti-5Al-5V-5Mo-3Cr alloy (Ti-5553). This also achieves an integrated production method for forged high-strength materials in a machine tool 1 so that for the first time, it is possible to perform a complete machining with short cycle times.

The machining method can be further simplified in its handling by replacing the material-removing tool 10 of the tool holder 12, as shown in FIG. 2, with the forging tool 11 in order to thus execute the incremental cold forging.

In addition, the workpiece 2 is completely machined, into the finished part 17 in only one clamping set-up on the machine tool 1, which further optimizes the operation sequence.

FIG. 2 also shows the multiaxial mobility of the tool holder 12. Its movement axes 19, 20, 21, 22 include three linear axes 19, 20, 21 and one rotation axis 22 about which the tools 10, 11 can be moved relative to the clamped workpiece 2. The forging tool 11 has a linear trajectory 23, which is independent of the movement axes 19, 20, 21, 22 of the tool holder 12 and along which the impact head 24 of the forging tool 11 is guided, as can be better inferred from FIG. 3. The incremental cold forging of the workpiece 2 can thus be carried, out independently of the movement axes 19, 20, 21, 22 of the tool holder 12, which enables advantageous machining conditions.

In addition, the tool holder has a connection 25 for controlling, regulating, and/or supplying energy to the electromagnetic forging tool 11 that it holds. The handling complexity when changing tools 10, 11 is therefore low since a short connecting line 26 of the forging tool 11 is all that is needed.

In addition, the tool holder 12 is associated with as supply unit 27 in order to cool and/or lubricate the machining region of the workpiece 2 with lubricant 28 as needed.

1. A method for machining a workpiece into a finished part, comprising:
clamping the workpiece into a machine tool and machining the workpiece in a material-removing fashion with a tool that has a geometrically defined cutting edge and is fastened to a multiaxially mobile tool holder of the machine tool; and
after its material-removing machining and in the same clamping set-up used for the material-removing machining, incrementally cold forging the workpiece in at least some regions with the aid of a forging tool to produce the finished part.

2. The method according to claim 1, comprising machining a forged workpiece.

3. The method according to claim 1, comprising machining a workpiece made of titanium or a titanium alloy.

4. The method according to claim 1, comprising hard machining and/or hard turning the workpiece with the tool in a material-removing way and incrementally cold forging the workpiece immediately after this hard machining and/or hard turning.

5. (canceled)

6. The method according to claim 1, comprising replacing the material-removing tool of the tool holder with a forging tool for the incremental cold forging.

7. The method according to claim 1, comprising machining the workpiece into the finished part in one clamping set-up on the machine tool.

8. The method according to claim 1, wherein the tool holder is embodied so that it is able to move in four axes.

9. The method according to claim 1, comprising cold forging the workpiece with an electrodynamic forging tool.

10. A machine tool for carrying out the method according to claim 1, comprising:
at least one clamping element for clamping, a workpiece that is to be machined;
a plurality of tools for machining the workpiece, wherein at least one tool has a geometrically defined cutting edge and is fastened to a multiaxially mobile tool holder for holding the tools; and
a forging tool for incrementally cold forging the workpiece, wherein the forging tool has an impact head that is guided along a trajectory that is independent of movement axes of the tool holder.

11. The machine tool according to claim 10, wherein the tool holder has a connection for controlling, regulating, and/or supplying energy to the electromagnetic forging tool that it holds.

12. The machine tool according to claim 10, wherein the machine tool has a forged workpiece made of titanium or a titanium alloy.
